(19) United States
(12) Patent Application Publication
(10) Pub. No.: US 2011/0158678 A1
(43) Pub. Date: Jun. 30, 2011

(54) Printer with a touch panel

(75) Inventors: See-Hing Tiang, City of Industry, CA (US); Khairil Singgih, City of Industry, CA (US)

(73) Assignee: EVEN SYSTEMS COMPANY LTD., TAIPEI CITY (TW)

(21) Appl. No.: 12/654,726

(22) Filed: Dec. 30, 2009

(51) Int. Cl. G03G 15/00

(52) U.S. Cl. 399/107; 399/110

(57) ABSTRACT

A printer has a base, a cover, a touch panel, a printing module and a detachable bracket. The base has two mounting rails. Each mounting rail has an engaging slot and an engaging protrusion. The cover is mounted detachably on the base. The touch panel is mounted on the base. The printing module is mounted detachably on the base and covered by the cover. The detachable bracket is mounted securely on the printing module and has a bottom plate and two opposite side plates. Each side plate has an engaging tab and an engaging notch detachably engaging the engaging slot and protrusion of a corresponding mounting rail. The printer with the mounting rails and detachable bracket allows the printing module to be repaired independently without disassembling the touch panel.

### BACKGROUND OF THE INVENTION

1. Field of the Invention

The present invention relates to a printer, and more particularly to a printer that has a base, a touch panel and a printing module mounted detachably on the base. The printing module may be detached easily and conveniently from the base easily for repair and maintenance.

2. Description of Related Art

Ordering/checkout machines are commonly electronic devices used on counters in restaurants, department stores, supermarkets and grocery stores for ordering dishes and paying. A conventional ordering/checkout machine has a monitor and a keyboard for inputting orders therein. An improved ordering/checkout machine with a touch panel, which is more compact, has been developed recently so that a user may quickly input an order or goods information into the ordering/checkout machine on through the touch panel. Accordingly, working efficiency is increased to prevent customers intending to pay from waiting in a long queue.

The aforementioned ordering/checkout machine also has a printer incorporated with the touch panel so is capable of printing order/good lists as notes or for checking between clerks and customers. Because the printer is incorporated with the touch panel ordering/checkout machine, repairing the printer requires disassembly of the touch panel, which is time wasting and lowers repairing efficiency.

To overcome the shortcomings, the present invention provides a printer with a touch panel to mitigate or obviate the aforementioned problems.

### SUMMARY OF THE INVENTION

The main objective of the invention is to provide a printer that has a base, a touch panel and a printing module mounted detachably on the base. The printing module may be detached easily and conveniently from the base easily for repair and maintenance.

A printer in accordance with the present invention has a base, a cover, a touch panel, a printing module and a detachable bracket. The base has two mounting rails. Each mounting rail has an engaging slot and an engaging protrusion. The cover is mounted detachably on the base. The touch panel is mounted on the base. The printing module is mounted detachably on the base and covered by the cover. The detachable bracket is mounted securely on the printing module and has a bottom plate and two opposite side plates. Each side plate has an engaging tab and an engaging notch detachably engaging the engaging slot and protrusion of a corresponding mounting rail.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a printer with a touch panel in accordance with the present invention;

FIG. 2 is an exploded perspective view of the printer in FIG. 1;

FIG. 3 is a front perspective view of a base of the printer in FIG. 2;

FIG. 4 is an operational cross sectional side view of the printer in FIG. 2;

FIG. 5 is an operational cross sectional side view of the printer in FIG. 4;

FIG. 6 is a perspective view of the printer in FIG. 1 without a cover; and

FIG. 7 is an enlarged perspective view of the printer in FIG. 6.

### DETAILED DESCRIPTION OF THE PREFERRED EMBODIMENT

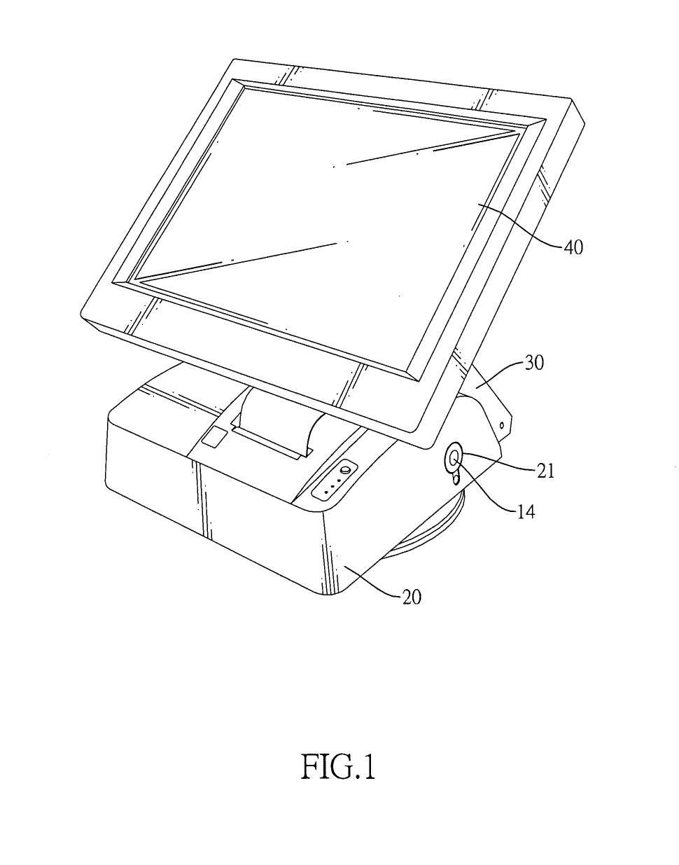

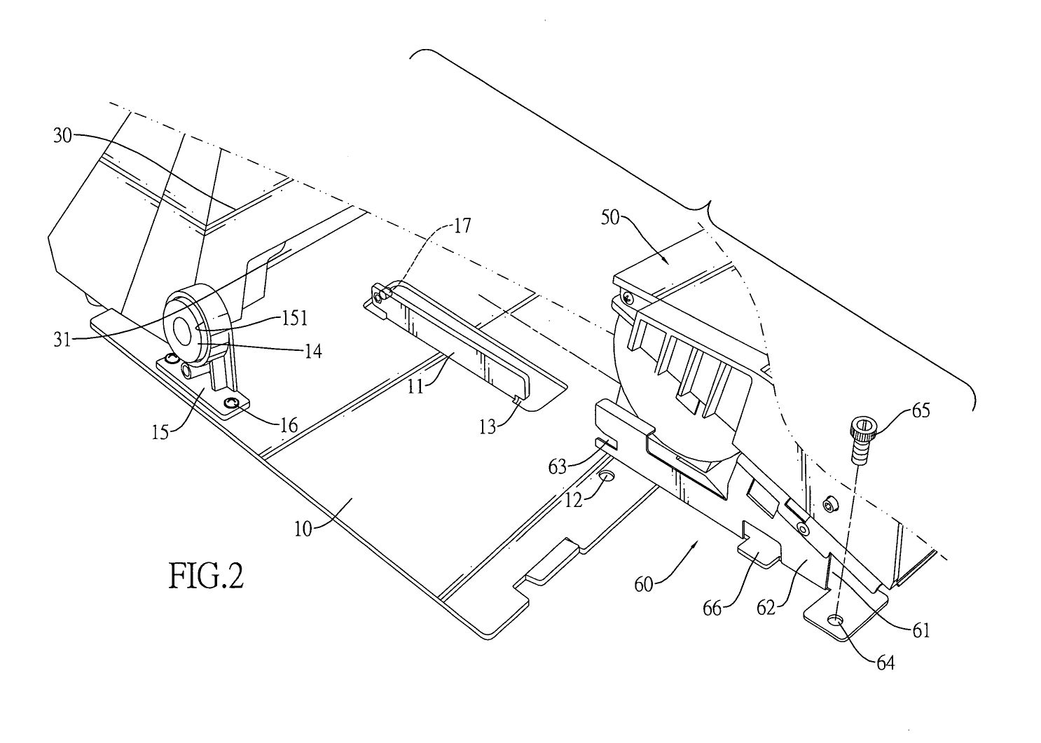

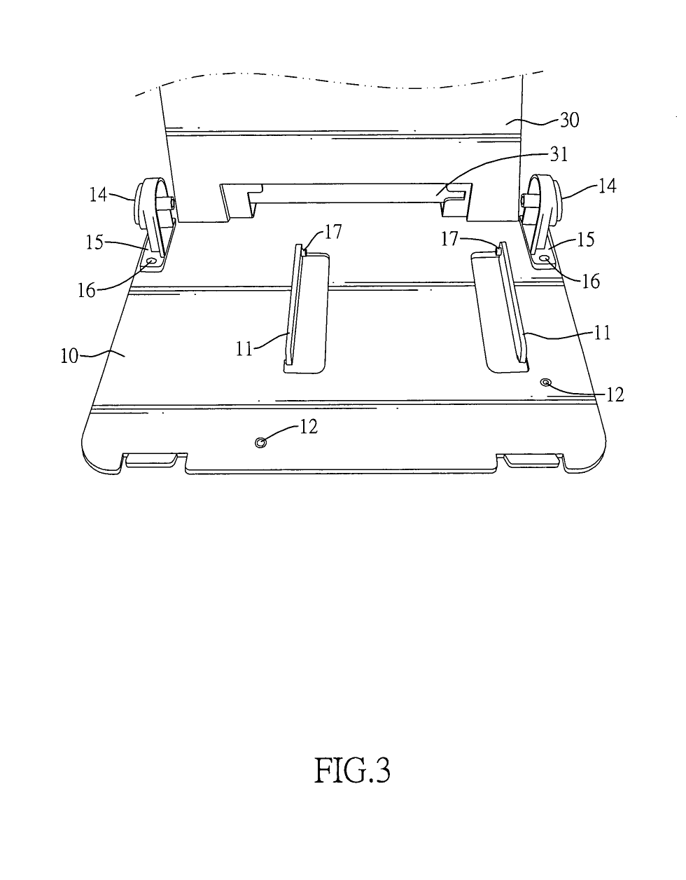

With reference to FIGS. 1 to 3, a printer in accordance with the present invention comprises a base (10), a cover (20), a touch panel (40), a printing module (50) and a detachable bracket (60).

The base (10) has a front, a rear, a top surface and two mounting rails (11) and may further have two pin brackets (15), two retractable locking pins (14), multiple fastening holes (12) and a supporting bracket (30).

The mounting rails (11) are mounted oppositely on the top surface of the base (10) and are parallel to each other. Each mounting rail (11) has a front end, a rear end, an inside, an outside, an engaging slot (13) and an engaging protrusion (17). The engaging slot (13) is defined in the front end. The engaging protrusion (17) is formed on and protrudes transversely from the inside.

The pin brackets (15) are mounted oppositely on the top surface of the base (10). Each pin bracket (15) may be fastened on the top surface through multiple fasteners (16) such as bolts and has a pin hole (151) defined in the pin bracket (15).

The retractable locking pins (14) correspond to and are mounted respectively in the pin holes (151) of the pin brackets (15), protrude respectively from the pin brackets (15) and are capable of retracting respectively into the pin brackets (15). Furthermore, each retractable locking pin (14) may be forced by a spring in a corresponding pin bracket (15) to extend out.

The fastening holes (12) are defined through the base (10) and may be threaded.

The supporting bracket (30) is mounted securely on the top surface at the rear of the base (10) and may have a cable hole (31). The cable hole (31) is defined through the supporting bracket (30) to allow data transmission and power cables to extend therethrough.

The cover (20) is hollow, is mounted detachably on the base (10) and may have two sides and two locking holes (21). The locking holes (21) are defined respectively through the sides and detachably and respectively engage the retractable locking pins (14) of the base (10). Pushing and disengaging the locking pins (14) from the locking holes (21) allows the cover (20) to be detached from the base (10).

The touch panel (40) is connected to the base (10) and may be connected pivotally to the supporting bracket (30) so that a user may pivot the touch panel (40) for optimizing elevational angle of the touch panel (40).

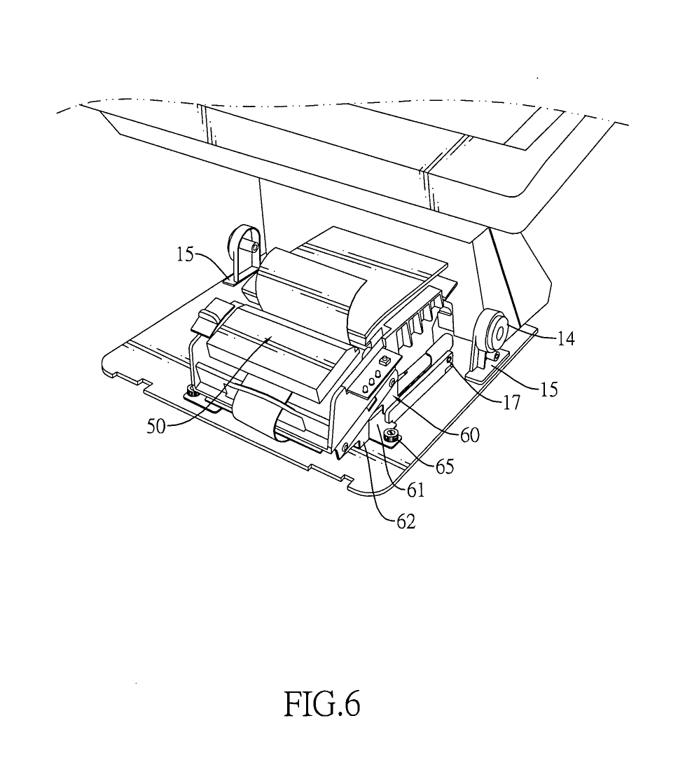

With further reference to FIG. 6, the printing module (50) is mounted detachably on the base (10), covered by the cover (20) and electrically connected to the touch panel (40) through cables such as power and data transmission cables.

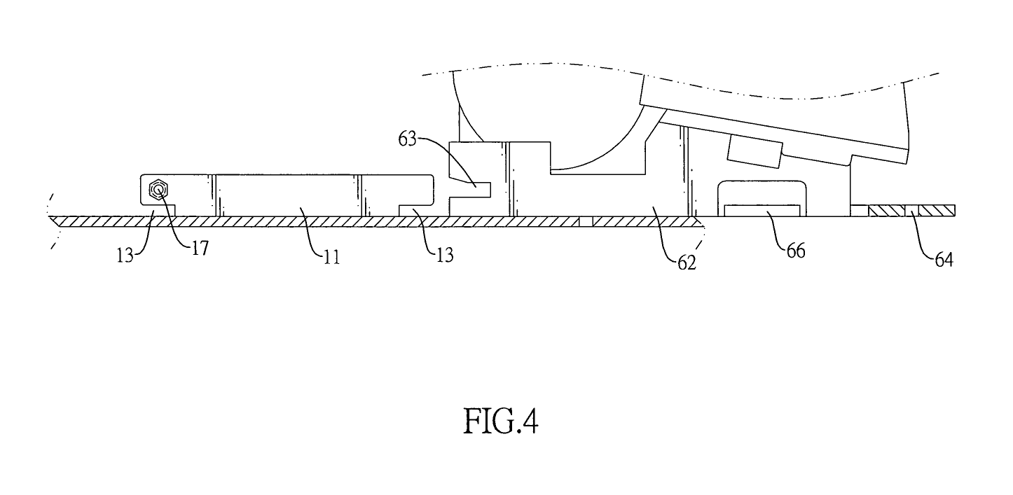

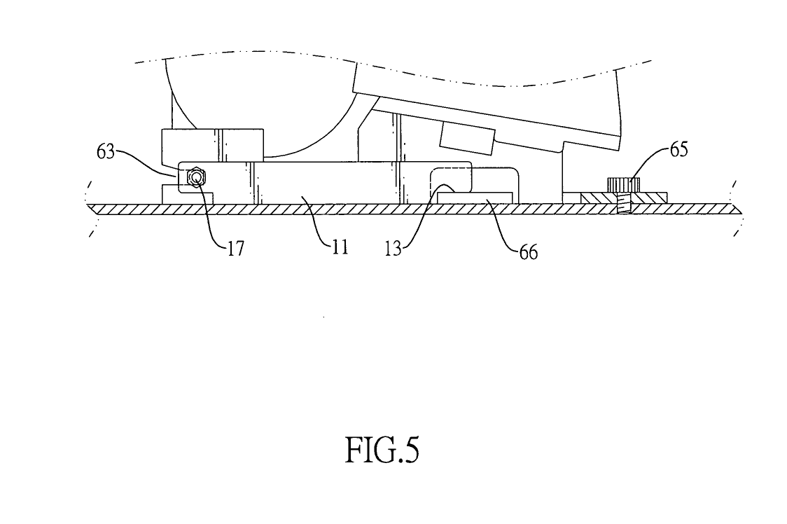

With further reference to FIGS. 4 and 5, the detachable bracket (60) is mounted securely on the printing module (50) and detachably engages the mounting rails (11) of the base (10) so that the printing module (50) is mounted detachably on the base (10) through the detachable bracket (60). The detachable bracket (60) has a bottom plate (61) and two opposite side plates (62) and may further have multiple fastening bores (64) and multiple fastening elements (65).

The bottom plate is mounted securely under the printing module (50).

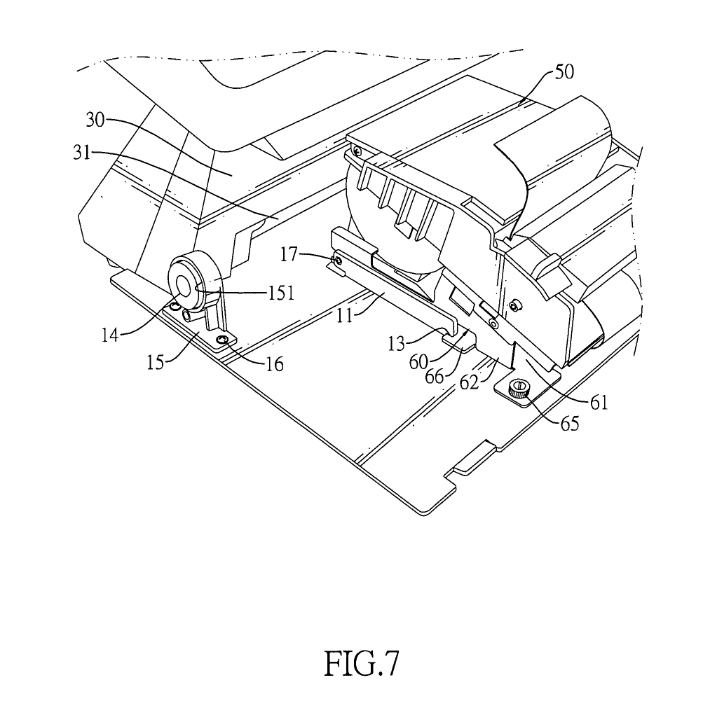

With further reference to FIG. 7, the side plates (62) are formed on and protrude upward from the bottom plate (61) and correspond to and detachably, slidably and respectively engages the mounting rails (11) of the base (10). Each side plate (62) has a front end, a rear end, an engaging tab (66) and an engaging notch (63). The engaging tab (66) is formed on and protrudes transversely outward from the side plate (62) and detachably engages the engaging slot (13) of a corresponding mounting rail (11). The engaging notch (63) is defined in the rear end of the side plate (62) and detachably engages the engaging protrusion (17) of the corresponding mounting rail (11).

The fastening bores (64) are defined through the bottom plate (61).

The fastening elements (65) are detachably mounted respectively through the fastening bores (64) and detachably mounted respectively in the fastening holes (12) of the base (10) so that the detachable bracket (60) is fastened on the base (10) without inadvertently disassembling.

The printing module (50) detachably mounted on the base (10) through the mounting rails (11) and the detachable bracket (60) is easily and conveniently disassembled for independent repair and maintenance without disassembling the touch panel (40). Therefore, repairing and maintaining the printing module (50) is simple and quick.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A printer comprising:
a base having a front, a rear and a top surface and further having two mounting rails mounted oppositely on the top surface and each mounting rail having a front end and a rear end and further having
an engaging slot defined in the front end; and
an engaging protrusion formed on protruding transversely from the mounting rail;
a cover mounted detachably on the base;
a touch panel connected to the base;
a printing module mounted detachably on the base, covered by the cover and connected electrically to the touch panel; and
a detachable bracket mounted securely on the printed module, detachably engaging the mounting rails of the base to make the printing module detachably mounted on the base and having
a bottom plate mounted securely under the printing module; and
two opposite side plates formed on and protruding upward from the bottom plate and corresponding to and detachably, slidably and respectively engaging the mounting rails of the base, and each side plate having a front end and a rear end and further having
an engaging tab formed on and protruding transversely outward from the side plate and detachably engaging the engaging slot of a corresponding mounting rail; and
an engaging notch defined in the rear end of the side plate and detachably engaging the engaging protrusion of the corresponding mounting rail.

2. The printer as claimed in claim 1, wherein
the base further has
two pin brackets mounted oppositely on the top surface of the base and each pin bracket having a pin hole defined in the pin bracket; and
two retractable locking pins corresponding to and mounted respectively in the pin holes of the pin brackets, protruding respectively from the pin brackets and being capable of retracting respectively into the pin brackets; and
the cover has
two sides; and
two locking holes defined respectively through the sides and detachably and respectively engaging the retractable locking pins of the base.

3. The printer as claimed in claim 2, wherein
the base further has multiple fastening holes defined through the base; and
the detachable bracket further has
multiple fastening bores defined through the bottom plates; and
multiple fastening elements detachably mounted respectively through the fastening bores and detachably mounted respectively in the fastening holes of the base.

4. The printer as claimed in claim 1, wherein
the base further has a supporting bracket mounted securely on the top surface of the base; and
the touch panel is connected pivotally to the supporting bracket.

5. The printer as claimed in claim 3, wherein
the base further has a supporting bracket mounted securely on the top surface of the base; and
the touch panel is connected pivotally to the supporting bracket.

6. The printer as claimed in claim 5, wherein the supporting bracket further has a cable hole defined through the supporting bracket.

7. The printer as claimed in claim 2, wherein each pin bracket is mounted on the base through multiple fasteners.

8. The printer as claimed in claim 6, wherein each pin bracket is mounted on the base through multiple fasteners.
